(19) United States
(12) Patent Application Publication
(10) Pub. No.: US 2009/0182920 A1
(43) Pub. Date: Jul. 16, 2009

(54) AUTOMATIC SERIAL INTERFACE ADDRESS SETTING SYSTEM

(75) Inventor: Kuo-Sheng Chao, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/034,666

(22) Filed: Feb. 21, 2008

(30) Foreign Application Priority Data
Jan. 11, 2008 (CN) 200810300077.5

(51) Int. Cl. G06F 13/00

(52) U.S. Cl. 710/110

(57) ABSTRACT

An automatic address setting system includes a master device, a plurality of slave devices are connected to the master device via a bus, a direct current (DC) power source, and a plurality of resistors connected in series between the DC power source and ground. Each of the slave devices includes an analog to digital (A/D) conversion pin. A node between every two adjacent resistors is exclusively connected to the A/D conversion pin of a corresponding slave device. Voltages at the A/D conversion pins of the slave devices are changed to different address signals of the slave devices.

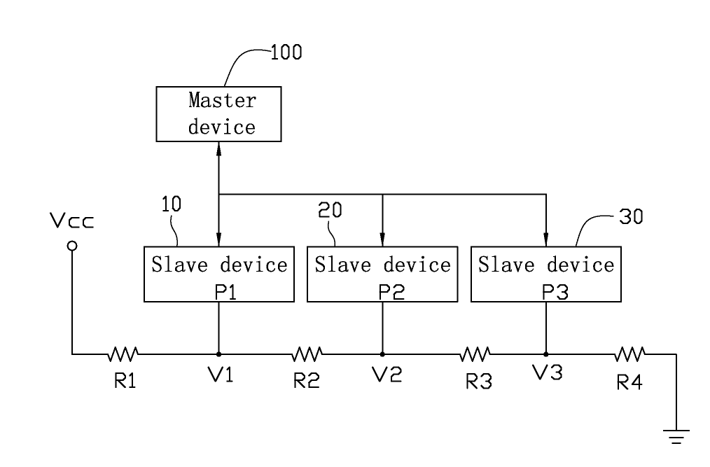

### BACKGROUND

1. Field of the Invention

The present invention relates to an automatic address setting system.

2. Description of related art

In communication circuits, serial interfaces such as RS485 serial interfaces are familiar communication interfaces for data communications between a master device such as a server and a plurality of slave devices such as uninterrupted power supplies (UPS). In communication between the master device and the slave devices, the master device transmits data to a slave device by using a number of the slave device. A slave device receives data corresponding to its own number and transmits response data to the master device. Thus the master device is able to transmit data to a slave device.

A way to set addresses of earlier RS485 control systems uses two rotary address switches to set the address. The two rotary address switches use a decimal format to set the addresses of the slave devices of the RS485 bus control system. When the RS485 bus control system includes several hundred or several thousand slave devices, setting the addresses of the slave devices is time consuming, and the possibility of mistakes is great.

What is desired, therefore, is to provide an automatic address setting system for automatically setting respective identification numbers for a plurality of slave devices constituting a network.

### SUMMARY

In one embodiment, an automatic address setting system includes a master device, a plurality of slave devices are connected to the master device via a bus, a direct current (DC) power source, and a plurality of resistors connected in series between the DC power source and ground. Each of the slave devices includes an analog to digital (A/D) conversion pin. A node between every two adjacent resistors is exclusively connected to the A/D conversion pin of a corresponding slave device. Voltages at the A/D conversion pins of the slave devices are changed to different address signals acting as addresses of the slave devices.

Other advantages and novel features of the present invention will become more apparent from the following detailed description of preferred embodiment when taken in conjunction with the accompanying drawing, in which:

### BRIEF DESCRIPTION OF THE DRAWINGS

The drawing is a circuit diagram of an automatic address setting system in accordance with an embodiment of the present invention.

### DETAILED DESCRIPTION

Referring to the drawing, an automatic address setting system in accordance with an embodiment of the present invention includes a master device 100, such as a computer system, a plurality of slave devices, such as three slave devices 10, 20, and 30, a direct current (DC) power source Vcc, and four resistors R1˜R4. The master device 100 is connected to the slave devices 10, 20, and 30 via an RS485 bus. The DC power source Vcc is grounded via the resistors R1, R2, R3, and R4 connected in series. An analog/digital (A/D) conversion pin P1 of the slave device 10 is connected to a node between the resistors R1 and R2. An A/D conversion pin P2 of the slave device 20 is connected to a node between the resistors R2 and R3. An A/D conversion pin P3 of the slave device 30 is connected to a node between the resistors R3 and R4.

When the master device 100 communicates with the slave devices 10, 20 and 30, the DC power source Vcc provides voltages V1, V2, and V3 to the A/D conversion pins of the slave devices 10, 20 and 30. The resistors R1, R2, R3, and R4 are provided for dividing voltage. According to the following formulas: the voltage V1=(R2+R3+R4)/(R1+R2+R3+R4)*Vcc, the voltage V2=(R3+R4)/(R1+R2+R3+R4)*Vcc, and the voltage V3=R4/(R1+R2+R3+R4)*Vcc.

In this embodiment, the voltage of the DC power source Vcc is 5V. The resistances of the resistors are R1=R2=R3=R4=1 ohm. The master device 100 uses 8 bit (256 values) A/D conversion. The voltage V1=(1+1+1)/(1+1+1+1)*5=3.75V, the voltage V2=(1+1)/(1+1+1+1)*5=2.5V, and the voltage V3=1/(1+1+1+1)*5=1.25V. The voltages of the A/D conversion pins of the slave devices 10, 20, and 30 are different. The voltages V1, V2, and V3 at the A/D conversion pins of the slave devices 10, 20, and 30 can be changed to values A1, A2, and A3 via A/D conversion. According to: Each value designated by the eight bits=5V/256=0.01953125V, A1=V1/(0.01953125V)=192, A2=V2/(0.01953125V)=128, and A3=V3/(0.01953125V)=64. The values A1, A2, and A3 are used as addresses of the slave devices 10, 20, and 30. The master device 100 can gain the addresses of the slave devices 10, 20, and 30 according to above formula. When the master device 100 sends an instruction to the slave devices 10, 20, and 30, the slave devices 10, 20, and 30 compare the address of the instruction from the master device 100 with their own address. The slave device having the identical address carries out the instruction from the master device 100 and communicates with the master device 100.

The automatic address setting system includes a simple address wire having resistors connected in series therein. The resistors act together as a voltage divider providing different voltages therebetween to the A/D conversion pins of the slave devices 10, 20, and 30. The voltages of the A/D conversion pins are changed to the address signals of the slave devices. Thus, the automatic address setting system is simple and low-cost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A serial interface automatic address setting system comprising:
a master device;
a plurality of slave devices connected to the master device via a bus, each of the slave devices comprising an analog to digital (A/D) conversion pin;
a direct current (DC) power source; and
a plurality of resistors connected in series between the DC power source and ground, a node between every two adjacent resistors being exclusively connected to the A/D conversion pin of a corresponding slave device, voltages at the A/D conversion pins of the slave devices being changed to different address signals acting as addresses of the slave devices.

2. The automatic address setting system as claimed in claim 1, wherein the master device is a computer system.

3. The automatic address setting system as claimed in claim 1, wherein the master device is connected to the slave devices via an RS485 bus.

4. The automatic address setting system as claimed in claim 1, wherein the DC power source is a 5V power source.

5. The automatic address setting system as claimed in claim 1, wherein the resistance of each of the resistors is 1 ohm.
